(19) United States
(12) Patent Application Publication
(10) Pub. No.: US 2010/0063429 A1
(43) Pub. Date: Mar. 11, 2010

(54) MULTIPLE POSITION FOOT MASSAGING DEVICE

(76) Inventor: Paul J. McClorey, Howell, MI (US)

Correspondence Address: STEVE M CLEMMONS, 33150 SCHOOLCRAFT, SUITE 207, LIVONIA, MI, 48150, US

(21) Appl. No.: 12/554,159

(22) Filed: Sep. 4, 2009

Related U.S. Application Data
(60) Provisional application No. 61/094,478, filed on Sep. 5, 2008.

(51) Int. Cl. A61H 15/00

(52) U.S. Cl. 601/122

(57) ABSTRACT

A foot massaging device having a plurality of parallel cylindrical rollers mounted within a frame. The frame includes adjustment slots allowing the rollers to be relocated within the frame to present various massaging configurations. The foot massaging device is adjustable by seating the rearwardly disposed rollers between a raised and lowered position to configure the rollers to contact different portions of a user's foot.

### CROSS-REFERENCE TO RELATED APPLICATIONS

This application claims priority of United States Provisional Patent Application filed Sep. 5, 2008 having Ser. No. 61/094,478.

### FIELD OF THE INVENTION

This invention is related to massagers and more particularly to a user manipulated foot massaging device.

### BACKGROUND AND SUMMARY OF THE INVENTION

Massage is a well-known technique to increase blood flow and ease muscle tension in a person's body. Typically, in a massage, pressure is applied to a location on the body either by direct hand/finger manipulation or through a device that aids in the application of pressure.

Such devices include both user-manipulated tools and motorized devices which vibrate, knead, and/or rotate to manipulate a desired body part. These massage tools may either be used by the individual receiving the massage or by another person (e.g., a masseuse).

One area of the body that frequently needs the therapeutic effects of massage is the foot, particularly the sole or bottom of the foot. Typical foot massagers have one or more sets of rollers rotatably mounted within a fixed frame. A user rolls his feet across the fixed rollers to apply massaging pressure to the bottom of his foot. These massagers, however, do not allow the user to change the location of the roller(s) in the frame and therefore cannot be configured to optimize the rollers position to target a particular part of the foot.

The broad purpose of the present disclosure is to provide a foot massaging device that has a plurality of foot contacting rollers which can be adjusted to massage various parts of the foot. The massager is adjustable by seating the rearwardly disposed rollers between a raised and lowered position to configure the massager to contact different portions of a user's foot.

The preferred massager includes a frame having opposed vertical walls. Three rollers are adjustably mounted in-parallel between the opposed walls. The rollers are mounted in a spaced relationship such that they present a front, middle and rear roller to a user. The middle and rear rollers being adjustable vertically within channels formed in each wall. In this manner, the middle and rear rollers can be selectively placed in a raised position (relative to the front roller) or in a lowered position where the axis(es) of rotation of the adjustable roller(s) are co-planar with the rotational axis of the front roller.

It is an advantage of the present disclosure that the massaging device allows a user to configure the device to massage a particular part of the foot.

The massager has a first position which aligns all of the rollers in-parallel allowing a user to roll his foot or feet across a substantially horizontal row of spaced massaging rollers. The second position sets the middle roller in the elevated position, while the rear roller is lowered. The second position allows the user to roll his foot along a curved profile to better follow the curvature of the foot's arch. A third position is possible by setting the rear roller in the elevated position, while the middle roller is lowered. In this third position, the front two rollers contact a user's foot bottom, while the rear roller contacts the top of the foot. A fourth position has both the middle and rear rollers in the elevated position, in this fourth position, the massager presents a substantially flat row of rollers that are at an angle relative to the ground (from front to back roller), in this fourth position a user can roll his feet across the rollers while sitting down in substantially the same way as the first position.

It is another advantage of the present disclosure that the rollers can be supplemented with a textured outer surface to further increase and vary the pressure exhibited on the user's feet when rolled across the device.

It is still another advantage of the present disclosure that each of the rollers is comprised of two axially aligned rollers which are independently rotatable about a common axis of rotation. In this manner, a user can roll both feet simultaneously across the rollers at different speeds and/or in opposite directions.

Still further objects and advantages of this disclosure will become readily apparent to those skilled in the art to which the invention pertains upon reference to the following detailed description.

### BRIEF DESCRIPTION OF THE DRAWINGS

The description refers to the accompanying drawings in which like reference characters refer to like parts throughout the several views and in which:

FIG. 1 is a perspective view illustrating a massaging device embodying the invention;

FIG. 2 is a front view of the massaging device;

FIG. 3 is a side view of one of the frame walls, illustrating the roller seat channels;

FIG. 4 is perspective, partially exploded view of a roller assembly;

FIG. 5 is a side schematic view showing the massaging device in a first roller configuration;

FIG. 6 is a side schematic view showing the massaging device in a second roller configuration;

FIG. 7 is a side schematic view showing the massaging device in a third roller configuration;

FIG. 8 is a side schematic view showing the massaging device in a fourth roller configuration;

FIG. 9 is a perspective, partially exploded view of a roller sleeve; and

FIG. 10 is a side, partial cut-away view showing an alternate embodiment of the roller assembly.

### DETAILED DESCRIPTION OF THE INVENTION

Referring now to FIGS. 1-4, a preferred foot massaging device or massager 10 is illustrated. Massager 10 includes a frame 12 which supports a plurality of rollers, denoted 14, 14a, and 14b when mounted in frame 12.

Frame 12 includes a pair of opposed vertical walls 16 which are interconnected by support bars 18 adjacent to the bottom ends of the walls. Each wall 16 is generally triangular in shape, angling from a lower-most front end 16a to an upper-most rear end 16b. Frame 12 is preferably formed from a rigid and durable material, such as metal or plastic. Resilient feet members 20 are mounted to the underside of frame 12.

As best shown in FIG. 3, each wall 16 includes three roller mounting apertures passing between the outer and inner surfaces of the wall. Each mounting aperture has at least one roller receiving or bearing surface that is equally spaced apart from the adjacent mounting aperture. In the preferred embodiment, the front aperture 22 has a cylindrical through bore. The other two roller mounting apertures 24 and 26 are formed having two roller bearing surfaces or seats formed by a slot or groove passing through the wall. Each slot 24, 26 has a substantially constant opening width 28 that is equal to the diameter of front aperture 22.

Both mounting slots 24, 26 have the same general “question-mark” shape, with a lower seat 24a, 26a at the bottom of the slot and an upper seat 24b, 26b in an upper portion of the slot. The upper seats 24b, 26b are vertically aligned with their respective lower seat 24a, 26a. To interconnect the two seats 24a, 24b and 26a, 26b, each slot has an elongated vertical portion 30 that is offset from the vertically aligned seats. Each portion 30 is preferably offset away from the seats in the direction of the front aperture 22. As shown, the vertical portion of the rear slot 26 is longer than the vertical portion of middle slot 24 to ensure that the upper seats 24b and 26b cooperate with front aperture 22 to form a substantially straight line.

The slot seats 24a, 24b and 26a, 26b all have a generally semi-circular bottom surface 34. The lower portion of each slot starts at the lower seat 24a, 26a, then rises vertically a distance that is two to fours times the slot width 28, then turns horizontally to the offset vertical slot portion 30. The upper portion of each slot 24, 26 curves up and away from vertical portion 30 returning back to a generally vertical orientation and then terminating at upper seat 26.

In the preferred embodiment, lower seats 24a and 26a are horizontally aligned with front aperture 22, while the upper seats 24b and 26b are also aligned with front aperture 22 at an acute angle to the horizontal. In the preferred embodiment, this angle is in the range of fifteen to sixty degrees. It should be appreciated that each of the respective apertures 22, 24, 26 is aligned with an identical aperture formed in the opposing wall. In this manner, the paired roller bearing surfaces (i.e., apertures 22, seats 24a and seats 24b in the opposing walls 16) are aligned and are substantially parallel to the ground.

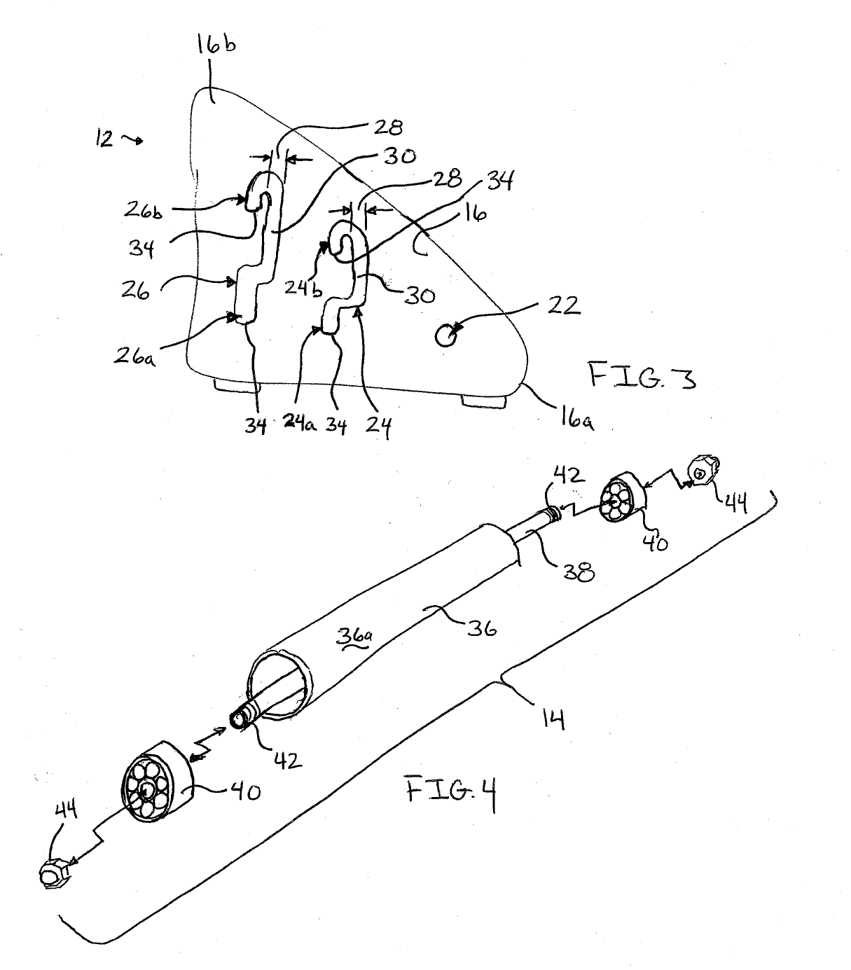

Referring now to FIG. 4, a roller assembly 14 is shown having a tubular body 36 that concentrically receives an elongated axle 38. Body 36 rotates about axle 38 via roller bearings 40 (e.g., ball bearings). The outer surface 36a of the body is generally smooth allowing a user's feet to roll over the surface.

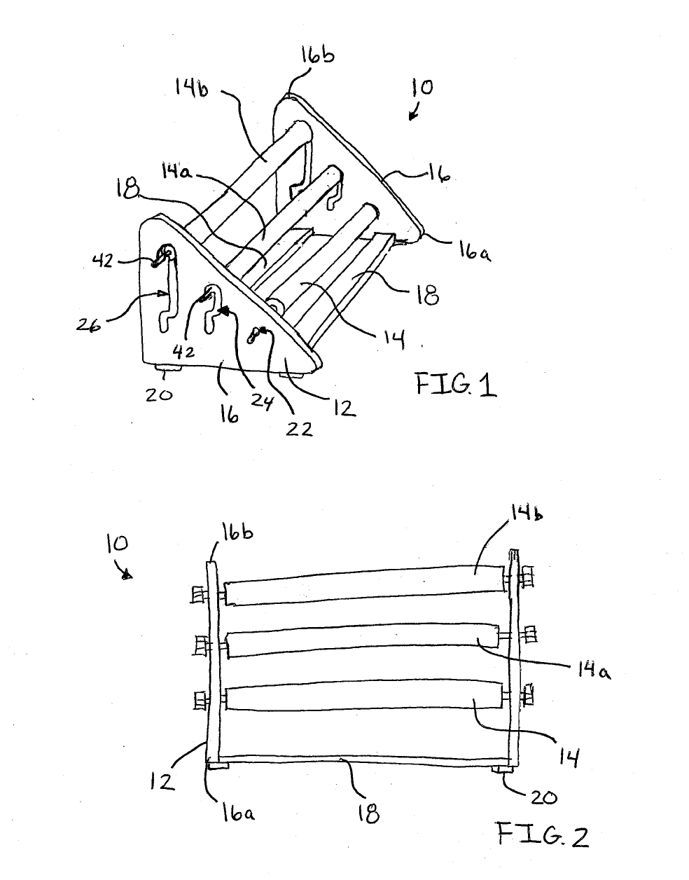

As shown in FIGS. 1 and 2, the outer ends 42 of the axle passes through the apertures 22, 24, 26 and are held within frame 12 by conventional fasteners 44. Three rollers 14 are mounted between the paired apertures 22, 24 and 26 wherein each roller body 36 is bounded by the opposing walls 16 and are substantially parallel to each other. The front roller 14a is mounted within front apertures 22, the middle roller 14b is mounted within middle apertures 24, and the rear roller 14c is mounted within the rear apertures 26. It should be appreciated that axle 38 is sized to fit within and slide along the circuitous shape of slots 24, 26 and is selectively positioned in either of the lower seats 24a, 26a or the upper seats 24b, 26b (as shown in FIGS. 1 and 2).

Referring now to FIGS. 3 and 5-8, the various roller configurations of the massager 10 are illustrated in schematic form depicting each roller's relative position when seated within a particular seat 24a, 24b, 26a, 26b.

FIG. 5 shows the middle roller 14b and the rear roller 14c positioned in the lower seats 24a and 26a, respectively, to present a substantially flat rolling surface to the bottom 48 of a user's foot 50 allowing the foot (or feet) to follow a substantially flat motion as shown in arrow 51.

FIG. 6 shows the middle roller 14b positioned in the upper seats 24b, while the rear roller 14c is in the lower seats 26a to present a convex curved surface, which follows the arch shape of a the bottom 48 of the foot as shown in arrow 52.

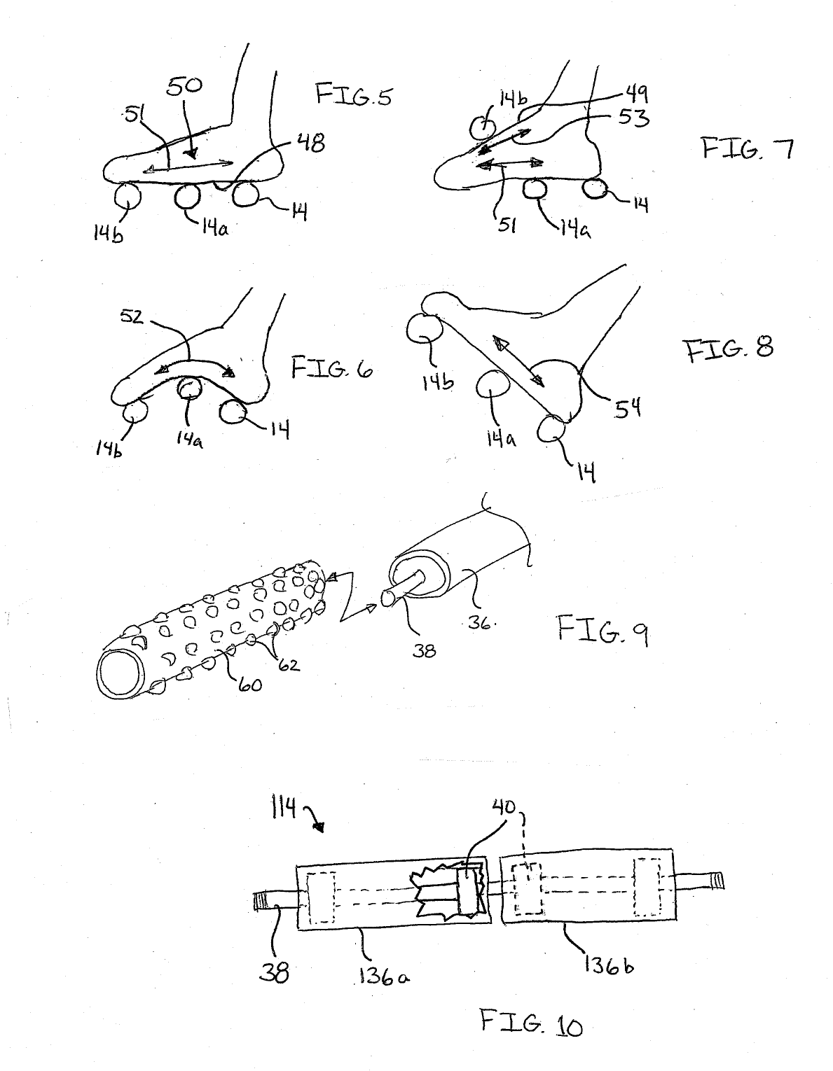

FIG. 7 shows the middle roller 14b positioned in the lower seats 24a, while the rear roller 14c is in the upper seats 26b to allow a user to roll both the top 49 of his foot (along arrow 53) and the bottom 48 of his foot (along arrow 51) against the massager.

FIG. 8 shows both the middle and rear rollers positioned in the upper seats 24b, 26b to present a flat angled massaging surface to the user's foot/feet in the directions of arrow 54. It is contemplated that this configuration is best used while the user is seated to reduce leg or knee strain during use.

Referring now to FIG. 9, massager 10 may optionally include a textured sleeve 60 having an internal bore sized to frictionally slide over the outer surface 36a of the roller body 36. Sleeve 60 is preferably formed from a tough, but pliable, material such as silicone or plastic and has a plurality of raised massaging ridges or nodes 62 covering the its outer surface. In other embodiments, the shape, size, and number of the ridges disposed on the outer surface can vary.

Referring now to FIG. 10, an alternate embodiment of the rollers is illustrated. In this embodiment, the roller, denoted 114, has separate tubular bodies 136a, 136b which independently rotate about the axle 38 on their own set of roller bearings 40. In this configuration, a user can roll both feet upon the massager 10 simultaneously in the opposite direction and/or at different speeds.

It should be appreciated that the adjustable slots 24, 26 may include various means to retain their respective rollers within a selected seat. In still other embodiments, the seats may be eliminated or supplemented where the rollers 14 are vertically adjustable along slots in the walls 16 and fixed in a desired location/height by placing the axle 38 in tension through hand-tightening fasteners, e.g., nuts 44, against the walls 16.

From the foregoing description, one skilled in the art will readily recognize that the present disclosure is directed to a foot massager having a plurality of rollers. While the present disclosure has been described with particular reference to various preferred embodiments, one skilled in the art will recognize from the foregoing discussion and accompanying drawing and claims that changes, modifications and variations can be made in the present disclosure without departing from the spirit and scope thereof.

For example and without limitation, while the present disclosure is shown having three roller receiving apertures in each wall, it should be appreciated that any number of apertures and rollers can be used accordingly. Further, while only two seats are disclosed in each adjustment slot, these slots can include any number of seats providing for greater adjustability in roller configuration/angle.

1. A foot massaging device comprising:
a frame having a pair of opposed vertical support walls;
a plurality of rollers, each roller being rotatably mounted to and between said opposed support walls; and
means for vertically adjusting at least one of said rollers relative to the other rollers.

2. A foot massaging device as defined in claim 1, wherein said vertical adjustment means comprises paired circuitous slots formed within said opposed support walls, each of said paired slots receiving a unique one of said rollers, each slot having at least two seat means which support the roller vertically.

3. A foot massaging device as defined in claim 2, wherein said at least two seat means are aligned vertically.

4. A foot massaging device as defined in claim 1, wherein said plurality of rollers is adjustable between a first position where said rollers are aligned along a horizontal plane and a second position where said rollers form an acute angle with said horizontal plane.

5. A foot massaging device as defined in claim 4, wherein said acute angle is within the range of fifteen to sixty degrees.

6. A foot massaging device as defined in claim 2, wherein the plurality of rollers comprises a front roller, a middle roller, and a rear roller, wherein said middle roller and said rear roller include said vertical adjustment means.

7. A foot massaging device as defined in claim 6, wherein the slots receiving said rear roller is configured such that said rear roller is adjustable higher within said frame than said middle roller.

8. A foot massaging device comprising:
a frame having opposed vertical walls; and
three rollers which are adjustably mounted in-parallel between the opposed walls, the three rollers are mounted in a spaced relationship such that they comprise a front, middle, and rear roller;
the middle and rear rollers being adjustable vertically within channels formed in each wall;
wherein the middle and rear rollers can be selectively placed in a vertically raised position relative to the front roller or in a lowered position where axes of rotation of the three rollers are horizontally co-planar.

9. A foot massaging device as defined in claim 8, wherein each of said channels include an upper roller seat and a lower roller seat, said roller seats including a bearing surface that supports a roller axle.

10. A foot massaging device as defined in claim 9, wherein the upper roller seat and the lower roller seat within each respective channel are aligned vertically.

11. A foot massaging device as defined in claim 8, wherein the middle and rear rollers form an acute angle with the front roller relative to a horizontal plane when both are placed in a vertically raised position.

12. A foot massaging device comprising:
a frame having opposed vertical support walls; and
massaging means comprising a front, middle and rear roller, said middle and rear rollers being vertically adjustable relative to each other along channels formed within said support walls;
the massaging means being movable to a first position which aligns all of the rollers in-parallel allowing a user to roll his foot across a substantially horizontal row of spaced rollers to massage a bottom of the foot;
the massaging means being movable to a second position which sets the middle roller in an elevated position, while the rear roller is lowered, in this second position the massaging means allows the user to roll his foot on top of said roller to massage the foot bottom along a convex curved profile which mimics a foot's arch;
the massaging means being movable to a third position which sets the rear roller in an elevated position, while the middle roller is lowered, in this third position, the massaging means has the front and middle rollers contacting and massaging a user's foot bottom, while the rear roller contacts and massages a top of the foot;
the massaging means being movable to a fourth position which has both the middle and rear rollers in an elevated position, in this fourth position, the massaging means presents a substantially flat row of rollers that are at an acute angle relative to a horizontal plane from front to back roller, in this fourth position, the massaging means allows a user to roll his foot across the rollers to massage a bottom of the foot while sitting down in substantially the same way as the first position.
